(19) United States
(12) Patent Application Publication
(10) Pub. No.: US 2007/0194173 A1
(43) Pub. Date: Aug. 23, 2007

(54) Probe-style, quick-attach interconnect mechanism

(75) Inventor: Gerhard Paasche, Scappoose, OR (US)

Correspondence Address: ROBERT D. VARITZ, P.C., 4915 S.E. 33RD PLACE, PORTLAND, OR, 97202, US

(73) Assignee: MJD Innovations, L.L.C.

(21) Appl. No.: 11/787,504

(22) Filed: Apr. 16, 2007

Related U.S. Application Data
(62) Division of application No. 11/115,460, filed on Apr. 26, 2005.
(60) Provisional application No. 60/591,400, filed on Jul. 26, 2004.

(51) Int. Cl. B64D 11/00

(52) U.S. Cl. 244/118.5

(57) ABSTRACT

Dual-action, spring-biased, probe-style latching structure including (a) first and second reversibly moveable relative-motion components operatively associated with one another, and each moveable between spaced first and second limit positions, and (b) biasing springs for these components, each urging its associated component in a common direction toward the component's first limit position. Motion of the first component from its first limit position toward its second limit position, against the resistance of the first component's biasing spring, accommodates snap-response movement of the second component toward its first limit position, and motion of the second component from its first limit position toward its second limit position, against the resistance of the second component's biasing spring, accommodates snap-response movement of the first component toward its first limit position.

### CROSS-REFERENCE TO RELATED APPLICATION

This application is a Division of prior-filed, currently co-pending U.S. patent application Ser. No. 11/115,460, filed Apr. 25, 2005, for “Probe-Style Quick-Attach Interconnect Mechanism”. The entire disclosure content of that prior-filed application is hereby incorporated herein by reference.

### BACKGROUND AND SUMMARY OF THE INVENTION

This invention relates to a snap-action probe-style, quick-attach interconnect mechanism, also referred to herein as a quick attach/detach mechanism. For the purpose of illustration herein, a preferred and best-mode embodiment of the invention is described in a military-aircraft (helicopter) environment wherein the invention has been found to offer particular utility. There are, of course, many other applications for the invention, and a reading of this disclosure will make that very evident.

There are settings, such as within military helicopters, where hinged, fold-up/fold-down, rapid-deployment seat panels are installed. An illustration in a helicopter is such a seat panel which is provided for a flight engineer behind the pilot and copilot. There is a category of these seat panels which have support legs equipped at their bottom ends with elongate, releasable locking male couplers which latch, normally through conscious manual manipulation, with floor-mounted elongate, female latching receivers, thus to connect with one another for stabilization of a deployed seat panel. Such couplers and receivers are referred to herein collectively as interconnect mechanism.

In this form of interconnect mechanism, the male coupler is elongate, and of “probe” or “stinger” style. It possesses an elongate, specially shaped capture end which enters, with axial motion along the coupler's long axis, an “openable” and releasably “closeable”, elongate, complementary jaw-perimetered reception socket formed in the associated latching receiver. An axially shiftable, spring-biased, release-lock ring provided on the outside of the body of the receiver is initially, and necessarily, manually moveable in one direction along this body to initiate outward radial rocking motion and related “opening” of gripper jaws at the mouth of the receiver's socket—which jaws are designed releasably to grasp the capture end of the coupler. With reception of such a capture end, the spring which biases the release-lock ring shifts the ring to a condition wherein it, by cam action, radially inwardly rocks the gripper jaws to close and hold these jaws in a manner which captures the socket-inserted probe capture end of the coupler.

The present invention offers an improvement in this kind of interconnect mechanism by proposing an automatic, dual-acting, snap-action design approach.

In this invention, a probe end in a male coupler engages a unique, spring-biased plunger which is axially centrally disposed within a receiving socket in the elongate, hollow body of a female latching receiver. This plunger, in the absence of any connection existing between the receiver and an associated coupler probe end, operates by internal cam action to hold and retain the receiver's gripping jaws in an open (unlocking) condition. At substantially the same time, a provided, outside, spring-biased, longitudinally moveable, release-lock ring is held, under these circumstances, against the counteraction of yieldable resistance offered by its associated biasing spring, and specifically is held in a condition permitting plunger retention of the open (unlocking) state of the gripper jaws. It is, in fact, the open condition of these jaws per se which holds the release-lock ring in this “awaiting connection” disposition.

In the “awaiting connection” condition just described, the latching receiver sits “poised for action” somewhat in the sense of a spring trap awaiting tripping by its intended prey. As distinguished from prior art structure, no initial manual action is required to place the female receiver, also called herein a catch, in a condition ready to capture a male probe coupler.

Entrance of a coupler probe end into the poised and awaiting receiving socket drives the spring-biased plunger against the yielding resistance of its biasing spring. This, as a consequence, both (a) frees the jaws to close, and (b) releases the “awaiting connection” release-lock ring to shift, with a snap-action, and under the biasing-spring action which is produced by its associated biasing spring, into a condition cam-closing the jaws, thus to capture a now “trapped” coupler probe end. The biasing spring provided for the ring holds the ring in the “trapping receiver-locked condition”.

To undo the state of coupler/receiver interconnection, one simply shifts the release-lock ring against the resistance of its associated biasing spring to “free” the jaws for outward radial rocking. The biasing spring for the plunger then, also with a snap-action, shifts the plunger (with removal of the probe end from within the socket) to return the jaws by camming action to, and to hold (and retain) them in, their open and unlocked conditions.

As a further introductory way of thinking about this invention, set forth immediately below in paragraphs numbered by two Roman numerals are two characterizations of the invention. These and other appropriate characterizations will be more fully understood when the subsequent detailed description of the invention is read in conjunction with the accompanying drawings.

I. A probe-style, snap-action quick-auto-connect coupler/receiver structure including (a) a female receiver with a reception socket defined by (1) an inner, spring-biased axially-moveable plunger, and (2) radially distributed jaws which can swing inwardly and outwardly radially to created locked and unlocked conditions for the receiver, (b) a lock-release ring, also spring biased, shiftable between positions involving different cam engagements with the jaws to accommodate shifting of those jaws between locked and unlocked conditions, and (c) a male prong-like coupler engageable with the plunger on motion of the components to create an interlocked condition between the coupler and the receiver, with such prong/plunger engagement (1) releasing a retained unlocked condition in the jaws, and (2) enabling ring shifting motion with camming action to cause the jaws to close around the male coupler, thus to establish the mentioned quick-auto-connect interconnection.

II. A snap-action interconnect mechanism including a receiver with moveable gripping jaws, and a pair of spring-biased, common-directionally-urged, relatively shiftable gripping-jaw control elements, and a coupler engageable with one of those elements during an interconnect operation with respect to the receiver to shift that one element in one direction against the resistance of its biasing spring in a manner (a) enabling closure of the jaws to grip the coupler, and (b) allowing spring-biased motion of the other element in the opposite direction to lock the jaws releasably in the coupler-gripping condition.

### DESCRIPTION OF THE DRAWINGS

FIG. 1 is a simplified schematic and fragmentary side-elevation illustration of a portion of an aircraft (helicopter) frame, floor and bulkhead, including a fold-up, fold-down, hinged seat with respect to which there is installed a preferred and best-mode embodiment of the present invention.

FIG. 2 is an isolated isometric view of the structure of the invention employed in the setting illustrated in FIG. 1. In this illustration, a female receiver and a male coupler are shown connected.

FIG. 3 is a view taken generally from the top of FIG. 2.

FIG. 4 is an enlarged view generally showing disconnected coupler and receiver components of the invention as employed with the aircraft and hinged seat in FIG. 1.

FIG. 5 is a cross-sectional view taken generally along the line 5-5 in FIG. 4.

FIGS. 6 and 7 are somewhat like FIGS. 4 and 5, respectively, but here showing the coupler and receiver of the invention connected to one another.

### DETAILED DESCRIPTION OF THE INVENTION

With attention directed first to FIG. 1, indicated generally at 10 is a fragmentary portion of a military helicopter having a frame 12, a floor 14, and a bulkhead 16 suitably anchored to frame 12. Joined to bulkhead 16 above floor 14 through a mount 18 and a horizontal pivot connection 20 is a fold-up, fold-down seat 22 which carries deployable, elongate leg structure including elongate slender legs, such as leg 24.

In solid lines in FIG. 1, seat 22 is folded up against bulkhead 16, and the leg structure is undeployed. In dashed lines, seat 22 is partially folded down and the leg structure is partly deployed. In dash-dot lines, seat 22 is fully folded down, and the legs, such as leg 24, in the leg structure are fully deployed, with the lower ends of these legs now anchored to floor 14 through a preferred and best-mode embodiment of the probe-style snap-action, quick attach/detach mechanism, or latching structure, of the present invention, shown generally at 26 in FIG. 1. In very general terms, mechanism 26 includes, for each leg in the mentioned seat leg structure, a male coupler 28 (shown in three different positions) secured to the bottom free end of each leg 24, and a female receiver 30 which is appropriately anchored to floor 14 at a location appropriate for engagement with coupler 28.

As was mentioned earlier, this military helicopter environment has been selected to illustrate the invention, inasmuch as the invention has been found to offer particular utility in this environment.

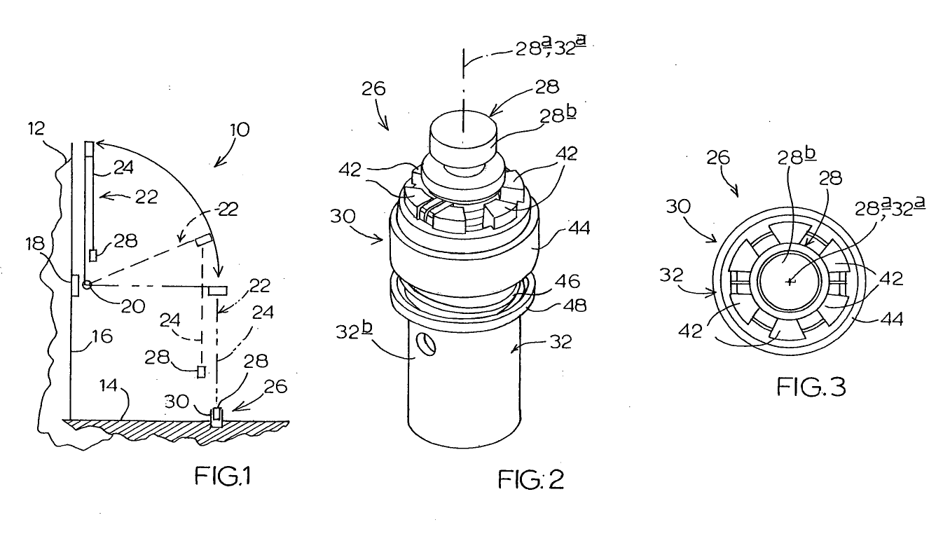

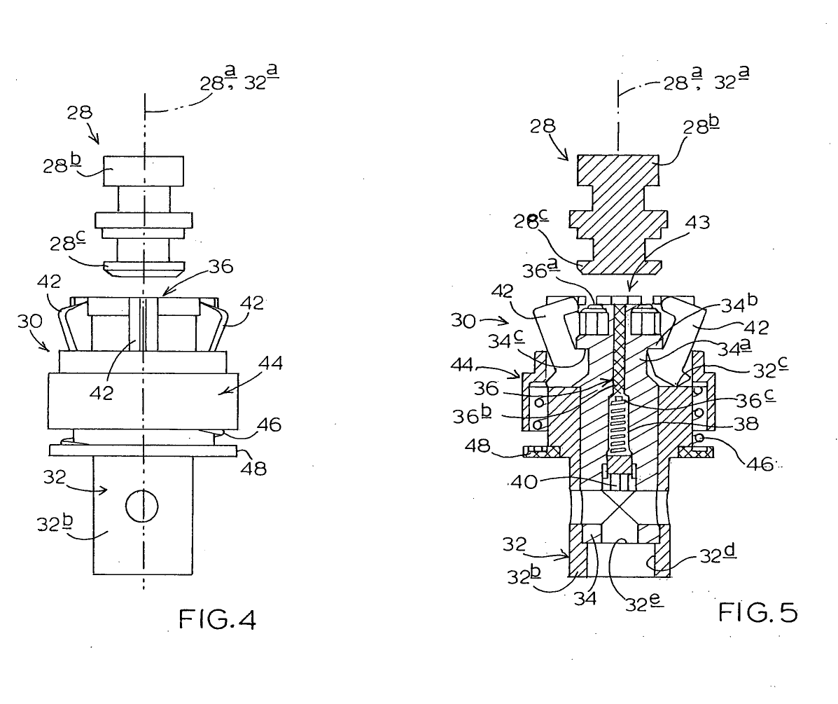

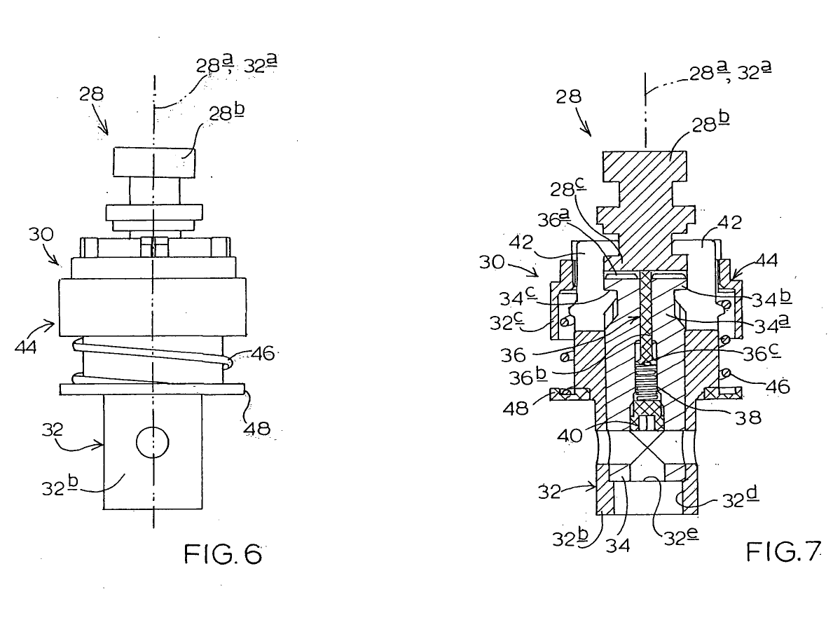

Adding attention now to the remaining drawing figures, male coupler 28 takes the form of an elongate, somewhat cylindrical body of revolution with a long axis 28a, and having the stepped-diameter configuration which is clearly illustrated in the drawings. Coupler 28, which us also referred to herein both as a prong-like coupler, and as a catchable element, has an upper end region 28b which is suitably fastened to the lower end of an associated seat leg 24, and a lower end portion 28c which is the part of coupler which functions prong-like, or stinger-like, to be captured by receiver. In FIGS. 2, 3, 6 and 7, coupler 28 is shown in a captured and locked status with respect to receiver 30. In FIGS. 4 and 5, it is shown in a free, uncaptured status.

Receiver 30, also referred to herein as a catch and as latching mechanism having locking and unlocking conditions, is shown in FIGS. 2, 3, 6 and 7 in its locking condition, and in FIGS. 4 and 5 in its unlocking condition. Receiver 30 includes (a) an elongate tubular, stepped-diameter body of revolution 32, with a long axis 32a, (b) a lower end portion 32b via which the receiver is anchored to floor 14, (c) an upper end portion including an upwardly facing, annular, outside shoulder 32c, and (d) a central, hollow cylindrical interior 32d which includes an internal, upwardly facing shoulder 32e.

Seated in interior 32d, and resting on shoulder 32e, is an elongate central core element 34 which is through-bored from upper to lower ends in a stepped-diameter fashion as shown, The upper part of element 34 possesses a recessed diameter portion 34a which terminates at its upper end with an “over-hanging” cap portion 34b which possesses a downwardly facing shoulder 34c.

Mounted for relative-motion reciprocation in the central, axial throughbore portion of element 34 is a plunger 36 which includes a plunger head 36a, and a screw shank 36b joined to a screw head 36c. Plunger 34, which is also referred to herein as a first relative motion component, as a control element, and as a cam-action engagement device, is upwardly biased in the drawings by a compressed biasing spring 38 which reacts between the screw head 36c and a screw-adjustable component 40 which is threaded into the lower end of the axially central throughbore in element 34. Component 40 is accessible for adjustment through the lower axial ends of body 32 and element 34, and this adjustment is provided for setting the upward biasing force which spring 38 exerts on plunger 36. This adjustment is made before installation of receiver 30 for use. Spring 38 is also referred to herein as a first component-associated biasing spring.

Spring 38 urges plunger 36 toward the raised, first limit position shown in FIG. 5. where upward shifting of the plunger is limited by engagement of plunger screw head 36c with the very evident downwardly facing shoulder in element 34 which can be seen in FIG. 5. With upward shifting of plunger 36, the perimeter of plunger head 36a acts herein as a camming instrumentality with respect to a plurality (six) of rocker jaws 42 having the side outlines clearly shown in FIGS. 5 and 7. Jaws 42 are shown in solid lines in FIGS. 2, 3, 6, and 7 rocked fully inwardly in conditions gripping lower end portion 28c in coupler 28. In FIG. 5, the jaws are shown fully rocked outwardly, with their lower ends in this figure resting on previously mentioned shoulder 32c. Movement of the jaws from their full inward to their full outward conditions is principally effected by camming action produced by raising of plunger 36, with plunger head 36a engaging and driving the rocker jaws outwardly. An examination of the two cross-sectional views presented in FIGS. 5 and 7 will clearly explain visually how this action takes place.

In FIG. 7, plunger 36 is shown in what is referred to as its second limit position.

Plunger head 36a and rocker jaws 42 collectively define what is referred to herein as a reception socket 43 (see FIG. 5). It is this reception socket which, by way of “prong” or “stinger” action, receives and captures the lower end of coupler 28.

It should be noted that with the various structural elements occupying the conditions shown in FIG. 5, bare, but appropriate, clearance is provided for coupler lower end portion 28c to pass between the rocker jaws to contact plunger 36. It is in the conditions illustrated in this figure that receiver 30 strands poised to receive and capture coupler 28. As has been mentioned, plunger 36a, by engaging the rocker jaws as shown, holds (retains) things in this condition.

Completing a description of structure shown in the drawings, disposed on the outside of receiver body 32 is (a) a moveable lock/release ring 44 (also referred to as a second relative motion component, as a control element, and as a cam-action engagement device), (b) a compression biasing spring 46, which is also referred to as a second component-associated biasing spring, and (c) an annular spring retainer 48 which is suitably anchored to body 32 at the location shown. Spring 46 acts between ring 44 and retainer 48, biasing ring 44 upwardly in FIGS. 2, 6 and 7 toward (and to) the position seen for this ring in these same three drawing figures. This position is referred to herein as a first limit position for the ring. In FIGS. 4 and 5, ring 44 is shown lowered to what is referred to as its second limit position.

What should be noted at this point herein is that movement of each of components 36, 44 toward its first limit position takes place upwardly in a common direction relative to receiver body 32. That is, both of components 36, 44 move in the same direction relative to body 32 toward their respective first limit positions. Further, when each of these components is in its own first limit position, it is held there by its associated biasing spring. Additionally, when each of these relative-motion components is so held in its first limit position by its respective associated biasing spring, that component effectively locks and holds the other relative-motion component in that component's second limit position.

With the plunger in its first portion, raised and holding the rocking jaws fully open, receiver 30 is then in its normal “awaiting a connection with coupler 28 condition”, with reception socket 43 open. Lock/release ring 44 is held lowered in its second limit portion, effectively by plunger 36 (via the outwardly rocked rocker jaws). This is referred to as the unlocking condition for receiver 30.

When, during a connection action, coupler lower end portion 28c enters the reception socket, passing the open socket jaws, engaging plunger head 36a, and then, by “probe” or “stinger” action, driving downwardly on the plunger 28 against the resistance of its biasing spring 38, a snap action takes place as soon as plunger head 36a “clears” the upper ends of the rocker jaws. When this clearing condition takes place, ring 44, under the biasing influence of its biasing spring 46, pops or snaps upwardly. This snap action creates a camming engagement between ring 44 and the rocker jaws, driving these jaws radially inwardly to “grip” coupler 28 at its upper end region 28b, as can be seen in FIGS. 2, 3, 6 and 7. This is referred to as the locking condition for receiver 30. In this condition of things, ring 44 effectively holds and retains plunger 28 in its second limit position (via engagements with the rocker jaws).

To unlock and release the captured coupler, ring 44 is manually moved downwardly against the resistance of its biasing spring. With sufficient downward shifting of this ring, another snap action takes place in the form of biasing spring 38 rapidly shifting plunger 28 upwardly toward its first limit position. When plunger head 28a again cammingly engages the rocker jaws, inasmuch as ring 44 has been shifted downwardly to permit this to occur, a camming action occurs to drive the rocker jaws back radially to free coupler 28 for detachment.

One modification of the invention which may be useful in situations where plural quick attach/detach mechanisms are involved, is to provide appropriate structure which enables manual unlocking and “freezing” of components in unlocked conditions, thus simplifying and enabling plural-mechanism, substantially simultaneous disconnections involving all associated mechanisms.

Thus a complete, dual, snap-action, connect/disconnect cycle has been described in relation to a unique, simple-to-operate dual-action, biasing-spring-assisted, quick-attach/quick-detach mechanism. Accordingly, while a preferred embodiment and one suggested modification of the invention has been illustrated and described herein, it is appreciated that variations and modifications may be made without departing from the spirit of the invention.

I claim:

1. A probe-style, quick attach/detach mechanism comprising
a female receiver having a body with a long axis, and including a reception socket defined by an inner, spring-biased axially-moveable plunger and radially distributed rocker jaws operatively associated with said plunger, which jaws can swing inwardly and outwardly radially to create locking and unlocking conditions, respectively, in said receiver, said plunger and jaws being relatively disposed whereby said jaws are retainable by said plunger in the unlocking condition of said receiver
a lock/release ring, also spring-biased, mounted on said receiver body for shifting longitudinally along the body between different relative positions thereon involving different contact-camming engagements with said jaws to accommodate radially inward and outward swinging of the jaws, and
a male, prong-like coupler axially engageable with said plunger to produce axial movement thereof which is operative to effect shifting of said receiver into its said locking condition with said coupler captured in said socket,
such shifting releasing a plunger-retained unlocking condition in said jaws, and enabling longitudinal shifting of said ring under the influence of its associated biasing spring in a manner producing contact-camming engagements with said jaws to create radial inward swinging of the jaws.

2. In an aircraft having a fold-up, fold-down seat with elongate leg structure having a free end which deploys toward adjacent aircraft floor structure when the seat is folded down, probe-style, quick attach/detach mechanism for releasably securing the leg structure's free end to the mentioned aircraft floor structure with folding down of the seat, said mechanism comprising
a female receiver attached to such floor structure and having a body with a long axis, and including a reception socket defined by an inner, spring-biased axially-moveable plunger and radially distributed rocker jaws operatively associated with said plunger, which jaws can swing inwardly and outwardly radially to create locking and unlocking conditions, respectively, in said receiver, said plunger and jaws being relatively disposed whereby said jaws are retainable by said plunger in the unlocking condition of said receiver
a lock/release ring, also spring-biased, mounted on said receiver body for shifting longitudinally along the body between different relative positions thereon involving different contact-camming engagements with said jaws to accommodate radially inward and outward swinging of the jaws, and
a male, prong-like coupler attached to such leg structure, axially engageable with said plunger to produce axial movement thereof which is operative to effect shifting of said receiver into its said locking condition with said coupler captured in said socket,
such shifting releasing a plunger-retained unlocking condition in said jaws, and enabling longitudinal shifting of said ring under the influence of its associated biasing spring in a manner producing contact-camming engagements with said jaws to create radial inward swinging of the jaws.
